(19) United States
(12) Patent Application Publication
(10) Pub. No.: US 2022/0201827 A1
(43) Pub. Date: Jun. 23, 2022

(54) SMART CONTROLLED LIGHTING SYSTEM

(71) Applicant: BIOLED ECO LIGHT SYSTEMS LTD, Kibbutz Tzova (IL)

(72) Inventor: Uriel Vulej, Givat Yearim (IL)

(21) Appl. No.: 17/692,028

(22) Filed: Mar. 10, 2022

Related U.S. Application Data
(63) Continuation-in-part of application No. PCT/IL2020/050984, filed on Sep. 9, 2020.

(30) Foreign Application Priority Data
Sep. 11, 2019 (IL) 269294

(51) Int. Cl. H05B 47/185; H05B 47/105

(52) U.S. Cl. CPC H05B 47/185; H05B 47/105

(57) ABSTRACT

A controlled lighting system which is capable of providing desirable illumination levels of different light spectrums by using one or more illumination units, via an electric supply network through which the illumination units are fed, and while keeping a steady illumination level or modifying the illumination according to preset parameters.

### BACKGROUND

### Technical Field

The present disclosure is in the field of controlled illumination. More specifically, the disclosure relates to a controlled lighting system providing controllable illumination for various applications, such as agricultural crops and buildings illumination.

### Description of the Related Art

Multiple applications of lighting systems are widely used in various buildings and facilities, starting with the most basic lighting system for illuminating the various sections of buildings, through more complex systems or facilities, such as industrial facilities, and even more complex systems where not only the light intensity is important, but the intensity of specific light frequencies and spectrums. For example, lighting systems utilized by agriculture applications in which certain illumination routines can significantly improve the plants' growth and particularly the flowers or foliage.

Existing controlled lighting systems require the deployment of data networks for controlling and communicating with the deployed illumination units, in addition to the electric power supply network, through which the illumination units are fed.

Therefore, it is an object of the present disclosure to provide an efficient lighting control system that eliminates the need for deploying a data network in addition to the power supply network.

Other objects and advantages of the disclosure will become apparent as the description proceeds.

### BRIEF SUMMARY

A controlled lighting system, comprising an encoder controller that is configured to control one or more illumination units according to preset parameters, via an electric supply network through which said illumination units are fed.

In one aspect, the power lines controlled lighting system comprising an encoder controller that is configured to control one or more illumination units by sending operational commands using Power Lines Communication (PLC), by switching the voltage and sending an encoded form of said operational commands in a one-way communication manner over the electrical power lines of an electric supply network through which said illumination units are fed, to the relevant illumination unit, wherein each operational command is designated for a specific illumination unit, thus when a new operational command is required, said encoder controller sends the new operational command to a designated illumination unit to be decoded by a decoder associated with said illumination unit.

In one aspect, the PLC sends a new operational command by a series of several subtractions of single half or full sinusoidal AC mains cycle, where the integer number of non-subtracted cycles between said single subtracted cycles, represent the data (e.g., 0 to 7, or 0 to 31, etc.) of said corresponding operational command bytes of power levels of illumination units.

According to an embodiment of the present disclosure, the encoder controller is adapted to receive feedback input from one or more sensors, in order to control the one or more illumination units.

According to an embodiment of the present disclosure, the sensors are selected from the group consisting of: photosensitive, humidity, temperature, CO₂, PH, O₂ levels, wind velocity, sound frequency and amplitude, camera/video camera, or any combination thereof.

According to an embodiment of the present disclosure, the system further comprises a remote computer configured to process data obtained from one or more sensors and to communicate with the encoder controller in order to adjust the preset parameters, in accordance with the processed data.

According to an embodiment of the present disclosure, the remote computer is a cloud-based computer.

According to an embodiment of the present disclosure, the system further comprises means for remotely monitoring said system.

According to an embodiment of the present disclosure, the monitoring means is at least one mobile device.

According to an embodiment of the present disclosure, the remote computer employs machine learning modules utilizing the process data for enhancing the preset parameters.

According to an embodiment of the present disclosure, the encoder controller controls the one or more illumination units by Sub-Hertz modulation.

According to an embodiment of the present disclosure, the encoder controller is configured to provide illumination levels of different light spectrums, while keeping a steady illumination level or modifying the illumination according to the preset parameters.

### BRIEF DESCRIPTION OF THE SEVERAL VIEWS OF THE DRAWINGS

FIG. 1 schematically illustrates one configuration of a controlled lighting system 100, according to an embodiment of the present disclosure;

FIG. 2A illustrates a block diagram of an optional configuration of an encoder controller, according to an embodiment of the present disclosure; and

FIG. 2B illustrates a diagram of an optional configuration of an illumination unit, according to an embodiment of the present disclosure.

### DETAILED DESCRIPTION

Various terms are used throughout the description and the claims which have conventional meanings to those with a pertinent understanding of the technical field. Additionally, various descriptive terms are used in describing the exemplary embodiments in order to facilitate the reader's understanding. However, while the description to follow may entail terminology which is perhaps tailored to certain artificial intelligence models that involve machine learning techniques that give computer systems the ability to “learn” with data without being explicitly programmed, such as progressively improve operation and performance of learning the response of agricultural crops to certain illumination routine, it will be appreciated by a person skilled in the art that such terminology is employed in a descriptive sense and not in a limiting sense. Where a confined meaning of a term is intended, it will be explicitly set forth or otherwise apparent from the disclosure.

The present disclosure relates to a controlled lighting system, which comprises an encoder controller that connects to light fixtures by the electricity lines (i.e., via Power Line Communication, or shortly PLC). The system is capable of providing desirable illumination levels of different light spectrums, while keeping a steady illumination level or modifying the illumination (i.e., or turning it off) according to preset parameters (e.g., turn on/off or change intensity of certain light spectrum according to daylight hours). The provided capability can be utilized for multiple different applications, such as Horticulture systems and light systems of buildings, and industrial facilities.

The proposed lighting system essentially comprises an encoder controller and at least one controlled illumination unit (i.e., a light fixture with a decoder that is suitable to receive PLC commands from the encoder controller), where the controls communication from the encoder controller runs over the power supply lines to each illumination unit, thereby reducing the need for deploying additional communication equipment, while providing an easy-to-deploy and low-cost controlled lighting system. According to an embodiment of the disclosure, the encoder controller controls, measures and monitors current, power and data. The encoder controller may also control scheduling, dimming and spectrum of each light fixture associated with it.

According to some embodiments of the present disclosure, the encoder controller receives local feedback from at least one sensing device such as Internet-of-Things (IoT) sensors, wired or wirelessly connected to the encoder controller (e.g., through LAN, WiFi, Bluetooth communication, etc.). For example, photosensitive sensors utilized by the proposed system for detecting the spectrum and the intensity of the existing illumination within a greenhouse (e.g., reduced sunlight during sunset hours, or an adjacent light source which may contribute to the overall illumination), or a desirable section of an industrial facility (e.g., increased sunlight during sunrise hours). The detected spectrum and intensity data are communicated to the encoder controller. The received data from sensors is compared to the desired preset levels, followed by the encoder controller transmitting desirable operational commands only to the illumination units associated with this specific encoder controller. For example, for increasing the flux at certain light frequencies in a desirable section of the greenhouse) or in the section of an industrial facility (e.g., reducing/turning off desirable illumination units were sufficient illumination provided by sunlight). Of course, multiple different sensors can be utilized by the invented system for monitoring various environmental conditions (e.g., light, humidity, temperature, CO₂, PH, O₂ levels, wind velocity, sound frequency and amplitude). According to an embodiment of the present disclosure, a camera is utilized in conjunction with an image processing unit is added, for enhancing the set of parameters, according to which the encoder controller controls the provided light intensity and spectrum (e.g., increasing the intensity of provided blue light frequencies for encouraging foliage growth rate at desirable age of the plants).

According to an embodiment of the disclosure, the PLC communication sends a new operational command by a series of several subtractions of single half or full sinusoidal AC mains cycle, where the integer number of non-subtracted cycles between said single subtracted cycles, represent the data (e.g., 0 to 7, or 0 to 31, etc.) of said corresponding operational command bytes of power levels of illumination units. In this way, the PLC communication between the encoder controller and the illumination unit is done by switching the voltage in a one-way communication manner through the electrical power lines. Such communication results in a relatively low rate through the electrical power lines.

Furthermore, the continuous growing experience and advanced sensing technologies may present in the future further environmental conditions or additional parameters, which can be detected by new sensors and contribute to further operational improvements. The proposed lighting system is modular, namely can be adapted for future expanded feedback input from added sensors and is not limited to sensors that are currently commercially available.

According to some other embodiments of the present disclosure, the encoder controller is adapted to communicate with at least one computing device (e.g., receiving updated preset parameters and/or operational commands from a computing device through an interne connection, or through a local wired or wireless connection). According to yet another embodiment of the present disclosure, the added connectivity to computing devices of higher processing capabilities enables the handling of mass data collected from multiple encoder controllers, to be processed by machine learning modules for providing enhanced operation. For example, learning that at certain PH and temperature levels of specific plants, reduced intensity of specific light frequencies results with the same desirable growth, followed by updating the relevant preset parameters in the relevant deployed lighting systems, thereby enabling energy cost reductions while keeping the desired production levels.

According to an embodiment of the disclosure, the system of the present disclosure may comprise IoT and Machine-Learning Server to improve performance on existing installations using crowd wisdom. For example, data from greenhouses and indoor crops such as quality, growth rate and the data received by the IoT sensors are constantly monitored, analyzed and applied to the system. Machine-Learning Algorithm may automatically modify parameters such as spectrum, intensity and timing settings (as per a user's choice).

Reference will now be made to several embodiments of the present disclosure, examples of which are illustrated in the accompanying figures for purposes of illustration only. One skilled in the art will readily recognize from the following description that alternative embodiments of the system and methods illustrated herein may be employed without departing from the principles of the claimed disclosure.

Moreover, the following discussion is intended to provide a brief, general description of a suitable computing environment adapted to be implemented in a controlled lighting system. While part of the disclosure will be described in the general context of program modules or codes that execute in conjunction with an application program that runs on a computer system, those skilled in the art will recognize that the disclosure may also be implemented in combination with other program modules. The functions described herein may be performed by executable code and instructions stored in computer-readable medium and running on one or more processor-based systems. Embodiments of the disclosure may be implemented as a computer process, e.g., a computer system that encodes a computer program of instructions for executing the computer process.

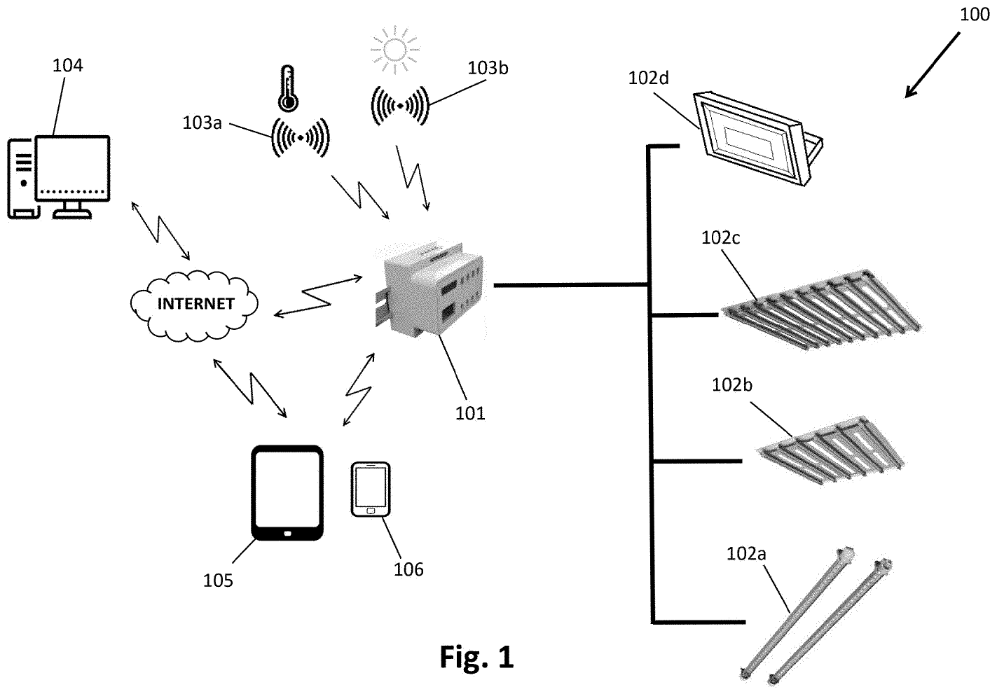

FIG. 1 schematically illustrates one configuration of a controlled lighting system 100, according to an embodiment of the present disclosure, in which system 100 comprises an encoder controller 101, and illumination units 102a-102d, wherein encoder controller 101 is exclusively connected to a utility electric power outlet (not shown), thus being supplied with standard utility voltage and current, thereby requiring minimal infrastructure preparations thus enabling a simple and low cost deployment of system 100. Encoder controller 101 is configured to control illumination units 102a-102d via PLC (i.e., via the electrical lines of an electric supply network through which said illumination units are fed), thus eliminating the need for deploying a data network in addition to the electrical lines of the power supply network.

One skilled in the art will realize the multiple different types of illumination units which can be integrated and controlled by system 100 per desirable applications, such as illumination units for flowering or foliage encouraging of agricultural crops, or flood light/focused illumination units intended for effectively covering large areas/defined areas, where an illumination unit may comprise one or more lamps such as LED lamps.

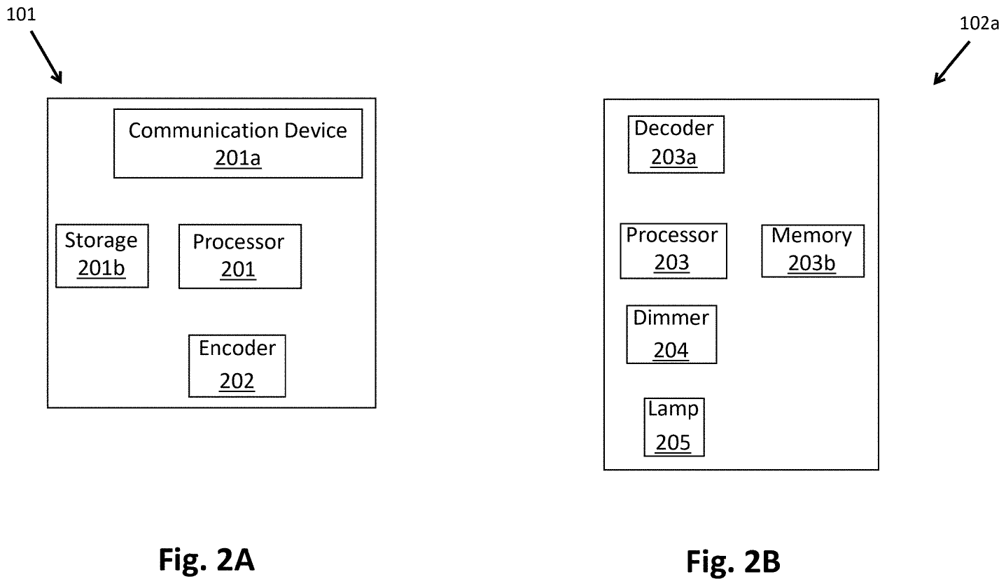

Encoder controller 101 is connected to illumination units 102a-102d via a corresponding decoder through the electrical power lines, and provides the required electric power for illumination. Encoder controller 101 employs a data encoder (further illustrated in FIG. 2A), for encoding specific operational commands to at least one designated decoder associated with at least one illumination unit, to which the operational commands are directed. Encoder controller 101 and the corresponding decoder communicate over the electrical power lines (by employing PLC) from which illumination units 102a-102d are fed. Each of illumination units 102a-102d employs a corresponding data decoder (e.g., as illustrated in FIG. 2B) for which encoder controller 101 can designate operational commands (e.g., using a unique network address). Encoder controller 101 is capable of transmitting encoded operational commands designated only for specific one or more illumination units 102a-102d, thus controlling the light intensity (i.e., including turning the light on/off) at desirable light spectrums produced by illumination a single or by multiple illumination units 102a-102c (i.e., or all together) through the encoded operational commands, according to preset parameters (e.g., which are programmed onto encoder controller 101, during the installation of system 100, or which are dynamically set by a corresponding cloud computing service). For example, a corresponding cloud computing service can be configured to collect data from one or more IoT sensors, and accordingly perform monitoring and analysis, e.g., by employing machine learning and artificial intelligence capabilities for enhancing cultivation performance.

As further shown in FIG. 1, encoder controller 101 receives feedback input from a temperature sensor 103a, and from a photosensitive sensor 103b, through a wireless network connection (e.g., WiFi, Bluetooth connection), thereby allowing the expansion of preset parameters, according to which encoder controller 101 controls illumination units 102a-102d. For example, while PLC 101 is initially set for turning on illumination units 102a-102d at a specific time (i.e., corresponding with the sunset time), illumination units 102a-102d will turn on when degraded natural illumination detected by sensor 103b (e.g., clouds during daytime hours), or illumination units 102a-102d will be turned off by encoder controller 101 earlier in the morning during summer period (i.e., due to earlier sunrise).

FIG. 1 further illustrates the connection of encoder controller 101 to a remote computer 104 running suitable operational program (e.g., central support and maintenance server) through an Internet connection, and to tablet 105 and smartphone 106 (i.e., having a suitable operational application), through optional Internet or local network connection (e.g., WAN, WiFi, LAN), where remote computer 104, tablet 105 and smartphone 106 can be utilized for routine monitoring of one or more deployed systems 100, and for updating the preset parameters and configuration of encoder controller 101. Tablet 105 and smartphone 106, can also communicate with remote computer 104 or with encoder controller 101 through an Internet connection, for example, where remote computer 104 runs a control and management program which includes a web interface which can be accessed through the Internet, thus allowing the monitoring and managing of encoder controller 101 by multiple different computing devices. Of course, suitable device identification and permissions tools are provided to prevent unauthorized access to computer 104 and to encoder controller 101.

According to an embodiment of the present disclosure, computer 104 is provided with high processing and storage capabilities, thus being capable of handling mass data collected from multiple encoder controllers of deployed systems, to be processed through machine learning tools for continuously improving and distributing the preset parameters to one or more systems 100.

FIG. 2A illustrates a block diagram of an optional configuration of encoder controller 101, according to an embodiment of the present disclosure, in which encoder controller 101 comprises a processor 201 running a suitable control program, a communication device 201a for communicating with different computing devices (i.e., as illustrated in FIG. 1), a storage 201b (e.g., computer memory card) which is utilized for storing the controls program, preset parameters, current operating status (e.g., current illumination intensity and spectrum of each illumination unit of units 102a-102c and further configuration and management information of system 100, and an encoder 202 which is utilized for encoding specific operational commands and at least one illumination unit (i.e., a corresponding specific decoder of at least one illumination unit, to which the operational commands are directed) onto the downstream electric power phases from which illumination units 102a-102d are fed. Encoder controller 101 receives feedback from sensors 103a and 103b of FIG. 1, e.g., directly or via a cloud computing service, compares the received information with preset parameters and accordingly determines if a new operational command should be transmitted to any illumination unit. When a new operational command is required, processor 201 sends the command to the relevant decoder (i.e., of the designated illumination unit) to be encoded by encoder 202 onto the downstream electric power phase. While being broadcasted over the common power lines that feed all illumination units 102a-102d, operational commands may be designated for a single lighting unit (e.g., increase the intensity of blue light produced by illumination unit 102a), for multiple units (e.g., turn of illumination units 102a and 102b) or for all illumination units 102a-102d together, (e.g., by encoding the desirable network addresses of all decoders for which an operational command is designated).

According to a preferred embodiment of the present disclosure, the encoding performed by encoder 202 is based on a Sub-Hertz Modulation of the electric power amplitude.

Of course, different configurations of encoder controller 101 will be selected by a person skilled in the art for specific applications, which may differ by different combinations of communication devices 201a, processors 201, or by added or subtracted elements (e.g., adding a machine learning capability, directly or indirectly, to encoder controller 101, for which more than one processor and/or storage units are required).

FIG. 2B illustrates a diagram of an optional configuration of an illumination unit 102a, according to an embodiment of the present disclosure. Illumination unit 102a comprises a decoder 203a, a lamp dimmer 204 and a lamp 205 (e.g., a LED lamp). Decoder 203a adapted to receive and decode the encoded commands executed by encoder controller 101 via the electrical power lines, and the received decoded commands are used to control the illumination of lamp 205 by lamp dimmer 204. According to some embodiments of the disclosure, the illumination unit may comprise a processor 203 and a memory 203b that can be configured to operate together with lamp dimmer 204 to form a driver to control lamp 205. For example, network address of a specific decoder and operational command to processor 203, which compares the received designated address to the unique network address of illumination unit 102a (i.e., which is stored in memory 203b) and if the addresses correspond, the received operational command is sent to dimmer 204 which accordingly provides a desirable electric power to lamp 205 for producing the desirable light intensity.

As illustrated by illumination units 102a-102d, multiple different types of illumination units can be embedded in system 100, which can comprise a single lamp, or multiple lamps (e.g., illumination units 102b and 102c) having a single spectrum of light (e.g., blue, red, infrared, white, ultraviolet, etc.) or a combination multi-spectral lamps.

As will be appreciated by the skilled person, the arrangement described in the figures results in a system that enables to convert any lighting system onto a smart IoT lighting system. An additional advantage provided by the disclosure is the information does not spread over the whole power grid, but each encoder is configured to power several individual devices (i.e., illumination units). Accordingly, the commands sent by a particular encoder reach only the illumination units associated with it (and are not sent to the whole power grid). Such configuration allows several encoders to be installed on the same power grid, since each specific encoder can only send commands for the illumination units connected to it. The system of the present disclosure includes an encoder that sends the information only to the illumination lighting units that it feeds. Therefore, a plurality of encoders can be installed without influencing or interrupting one another (as each encoder communicates only with the illumination units associated with it).

Although embodiments of the disclosure have been described by way of illustration, it will be understood that the disclosure may be carried out with many variations, modifications, and adaptations, without exceeding the scope of the claims.

The various embodiments described above can be combined to provide further embodiments. Aspects of the embodiments can be modified, if necessary to employ concepts of the various patents, applications and publications to provide yet further embodiments.

These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. A power lines controlled lighting system, comprising:
an encoder controller that is configured to control one or more illumination units according to preset parameters, by providing operational commands using Power Lines Communication (PLC), by switching the voltage and sending an encoded form of said operational commands in a one-way communication manner over the electrical power lines of an electric supply network through which said illumination units are fed, to the relevant illumination unit, wherein each operational command is designated for a specific illumination unit, thus when a new operational command is required, said encoder controller sends the new operational command to a designated illumination unit to be decoded by a decoder associated with said illumination unit.

2. The system according to claim 1, in which the encoder controller is adapted to receive feedback from one or more sensors, in order to control the one or more illumination units.

3. The system according to claim 2, in which the sensors are selected from the group consisting of: photosensitive, humidity, temperature, CO2, PH, O2 levels, wind velocity, sound frequency and amplitude, camera/video camera, or any combination thereof.

4. The system according to claim 2, further comprising:
a remote computer configured to process data obtained from the one or more sensors and to communicate with the encoder controller in order to adjust the preset parameters in accordance with the processed data.

5. The system according to claim 4, in which the remote computer is a cloud-based computer.

6. The system according to claim 4, further comprising means for remotely monitoring said system.

7. The system according to claim 6, in which the monitoring means is at least one mobile device.

8. The system according to claim 4, in which the remote computer employs machine learning modules utilizing the process data for enhancing the preset parameters.

9. The system according to claim 4, in which the one or more illumination units are controlled by Sub-Hertz modulation.

10. The system according to claim 1, in which the encoder controller is configured to provide illumination levels of different light spectrums, while keeping a steady illumination level or modifying the illumination according to the preset parameters.

11. The system according to claim 1, wherein the PLC sends a new operational command by a series of several subtractions of single half or full sinusoidal AC mains cycle, where the integer number of non-subtracted cycles between said single subtracted cycles, represent the data of said corresponding operational command bytes of power levels of illumination units.
